(19) United States
(12) Patent Application Publication
(10) Pub. No.: US 2015/0290088 A1
(43) Pub. Date: Oct. 15, 2015

(54) Universal nipple

(71) Applicant: Michael S. Farhi, Westchester, IL (US)

(72) Inventor: Michael S. Farhi, Westchester, IL (US)

(21) Appl. No.: 14/121,150

(22) Filed: Aug. 7, 2014

Related U.S. Application Data
(60) Provisional application No. 61/995,194, filed on Apr. 5, 2014.
(60) Provisional application No. 61/996,650, filed on May 13, 2014.

(51) Int. Cl. A61J 11/04

(52) U.S. Cl. CPC A61J 11/04

(57) ABSTRACT

A nursing nipple unit is disclosed which is readily portable by itself without being attached to a fluid supply and is adapted to be affixed to commonly sold water bottles or the like. The unit has a funnel member with a nursing orifice at one end and a flanged base at the other. A skirt attached to the base forms a socket which fits over the spout of a commercially available water bottle or similar container. A cable tie or comparable fastener may be wrapped around or through the skirt to draw it tightly around the spout.

This application claims priority of (1) the filing date of Apr. 5, 2014 of U.S. Provisional Application Ser. No. 61/995,194, and (2) the filing date of May 13, 2014 of U.S. Provisional Application Ser. No. 61/996,650, the entire contents of each of which are incorporated herein by reference.

### FIELD OF INVENTION

The invention described herein relates to nursing nipples which are applied to bottles of infant formula, water or similar fluids given to infants. More particularly, it relates to nipple assemblies which may be carried by themselves, independently from any fluid supply, and are adapted to be placed on the necks or spouts of commonly sold and readily available bottles of soft drinks, mineral water, or the like.

### BACKGROUND OF THE INVENTION

In U.S. Pat. No. 5,024,341, the patentee describes a nipple adapter for a bottle of mineral water having a threaded neck, said to be about 26-28 mm in diameter. In that patent, an adapter ring is shown which is screwed onto a bottle neck, and there is another threaded ring member screwed onto exterior threads on the adapter. The second threaded ring member threadably grasps a collar on the lower end of the nipple, thus holding the nipple on the bottle.

A generally similar arrangement is disclosed in U.S. Pat. No. 6,354,449. There, the patentee describes a housing which screws onto the threaded neck of a bottle and also has external threads which engage other threads on the inner walls of a cup-shaped cap. The cap, which rests on the top of a flange extending outwardly from the bottom end of a nipple, is arranged to screw down upon the external threads of the housing, thereby pulling the flange of the nipple down against a seal located in the top end of the housing. While the patent describes its device as “a nipple adapter in the form of a unitary assembly,” there are a number of parts in the device which have to be assembled before the device is complete.

The adapter shown in the '341 patent and the housing shown in the '449 patent are reflected in various forms in other patents such as U.S. Pat. Nos. 6,415,937; 6,851,565 and 7,185,775. In U.S. Pat. No. 7,481,324, the lower portion of an adapter is press-fit into the neck of a bottle, and its upper end is screwed into the internal threads of a cap which hold the bottom end of a nipple inside the cap. In U.S. Pat. No. 7,552,831 a special nipple, with a sealing flange about its middle and thread-engaging sealing flanges at its lower end, is fastened onto the threaded outside of a bottle neck by a separate internally threaded sleeve which draws the nipple and the bottle together with its threads.

A variety of other bottle cap systems may be found in United States Classes 206, 215, 222 and 227.

### SUMMARY OF THE INVENTION

Each of the above described inventions strives to sealingly connect a nursing nipple to an ordinary commercial bottle. Such bottles usually have a short tubular neck with external threads, or engageable lugs, or have internal passageways engageable with press-fitting connectors. Each of the patentees seems to have recognized the desirability of connecting nipples to bottles which are easily obtained wherever and whenever a need arises and thus avoid any necessity for carrying pre-prepared, pre-filled bottles. Yet all of the disclosed inventions seem to incorporate connectors which complicate the sealing interface between a nipple and the neck of a bottle. It is an object of the present invention to simplify that interface connection and also enable a user to make fluid-tight easy-to-make connections to a variety of readily available bottles at a moment's notice.

Thus, the present invention incorporates several elements in a nipple unit which may be used with bottles that are readily available to a user. It utilizes a funnel portion having an orifice at a first end for transmitting fluid out of the funnel, a base member at a second end of the funnel, a skirt member attached to and extending away from the base member forming a socket inside the skirt member adjacent to the base member, and a channel formed in and extending through the skirt member, the base member and the funnel member for transmitting fluid from a bottle to the orifice in the first end of the funnel.

### BRIEF DESCRIPTION OF THE DRAWINGS

The invention described herein will be well understood from the following description, given by way of example, with reference to the accompanying drawings in which:

FIG. 1 is a perspective view of the nursing nipple of this invention;

FIG. 2 is a sectional view in elevation of the nursing nipple of FIG. 1 taken along the line 2-2 in FIG. 1;

FIG. 3 is an enlarged sectional view of a portion of the nursing nipple shown in FIG. 2 showing the skirt member of the nursing nipple constrictively applied to the neck portion of a bottle shown in phantom;

FIG. 4 is an enlarged sectional view of a portion of the nursing nipple shown in FIG. 2 modified by including an ordinary bottle cap constrictively engaged in a socket formed within the skirt member of the nursing nipple shown in FIG. 2;

FIG. 5 is a perspective view of the nursing nipple of FIG. 1 modified by including a cable tie loosely disposed in and on the skirt member of the nipple;

FIG. 6 is an enlarged sectional view of the nursing nipple of FIG. 5 modified by a constrictive position of the cable tie holding the skirt member snuggly about the neck portion of a bottle shown in phantom; and

FIG. 7 is a sectional view of the nipple unit of FIG. 6 taken along the line 7-7 in FIG. 6.

### DESCRIPTION OF THE PREFERRED EMBODIMENTS

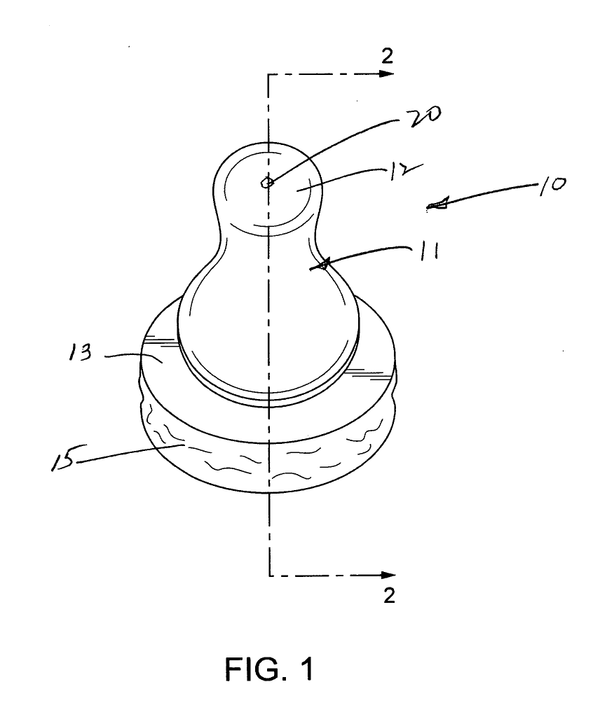

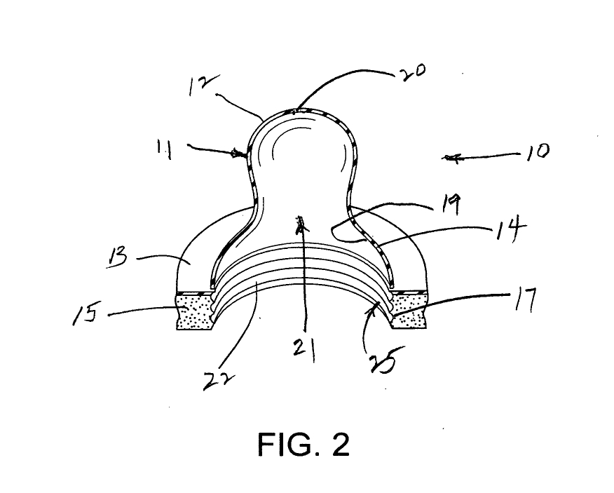

A nipple unit assembly 10 embodying the present invention is shown in FIG. 1. The upper portion of the assembly includes a nipple shaped funnel member 11 with an orifice 20 at its first end 12. A base member 13, shown as a flat flange extending outwardly from funnel member 11, is disposed adjacent the funnel member's second end 14. The funnel member 11 and base member are usually formed together and often made of a flexible silicone compound which can be readily used by an infant to nurse. A flexible skirt member 15 is attached to the base member on its underside, as shown in FIGS. 2 through 4, so that the skirt extends away from the base member 13. The skirt may be affixed on the entire underside of the base member, as shown in FIG. 2, or only to the periphery of the base member, as shown in FIG. 1.

The inner wall 17 of skirt 15 forms a socket 22 inside the skirt adjacent to the base member 13. Together, the inner walls 17 of skirt 15 and the inner walls 19 of funnel member 11 form a channel, shown at 21, in assembly 10 extending through the skirt member 15, the base member 13 and the funnel member 11 for transmitting fluid to orifice 20 at the funnel member's first end 12.

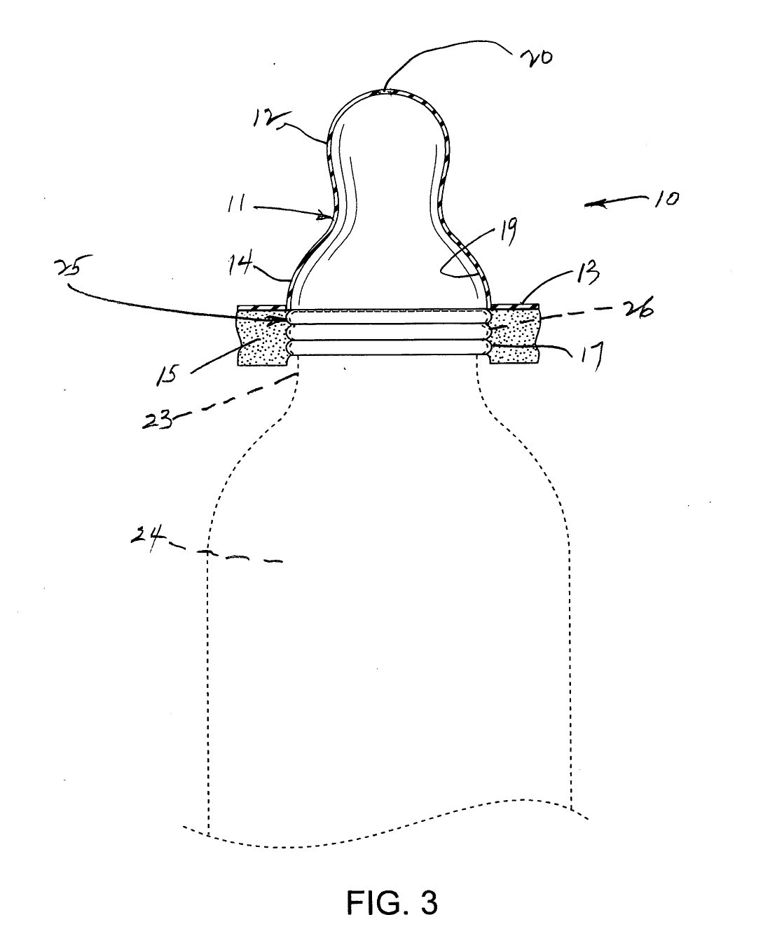

As shown in FIGS. 2 and 3, the assembly 10 may be mounted on the spout 23 of a bottle 24 utilizing threads 25 on the skirt walls 17 and arranged for sealing engagement on the complementary threads 26 on the bottle's spout 23. The threads may be continuous members, as in FIG. 2, or spread-apart lugs, as shown in section in FIG. 3, inside the skirt 15, so long as a sealing engagement is achieved and maintained between the inner walls 17 of skirt 15 and spout 23. Those skilled in the art will recognize, too, that a frictional, sealing engagement between walls 17 and spout 23 can also be achieved without the use of threads or lugs so long as skirt member 15 is sufficiently constrictive.

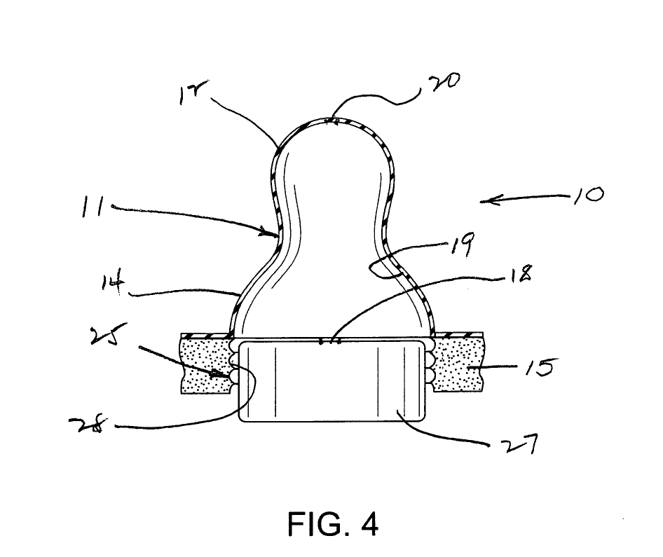

In FIG. 4, the assembly 10 as shown in FIG. 1 is modified by including a bottle cap 27 inside skirt 15. That cap 27 may be sized to fit the spouts of bottles having relatively common diameters in the range of 26-28 mm. The cap 27 is fixed inside skirt 15 by external corrugations 28 on the cap being embedded in the base member 13 of assembly 10. Oftentimes the corrugations 28 result by forming cap 27 out of metal when the cap is manufactured in order to form threaded configurations on the inside of the cap, although, if the cap is made of molded plastic, external configurations are frequently provided in the molding process in order to achieve an easily gripped outer surface. Configurations 28 may be regarded as illustrative of these alternatives. To engage them, the base member 13 of assembly 10 may be formed, as shown in FIG. 2, with lands and grooves, i.e., thread elements formed in walls of the skirt member 15 around the socket 22, which are complementary to the configurations 28 and interfit with them when cap 27 is twisted into engagement thereon. Alternatively, cap 27 may be fixed in the base member with an adhesive or by molding the cap and the base member together at the time the base member 13 and the funnel member 11 are manufactured.

The lid portion of cap 27 is provided with a hole 18 accessing the second end 14 of funnel 11 and leading into the cavity inside funnel 11. The hole 18 thus allows fluid to be drawn from a bottle (not shown), when cap 27 is affixed thereto, on into funnel 11, and from there drawn through orifice 20 in the first end of funnel 11 into an infant's mouth as the infant nurses.

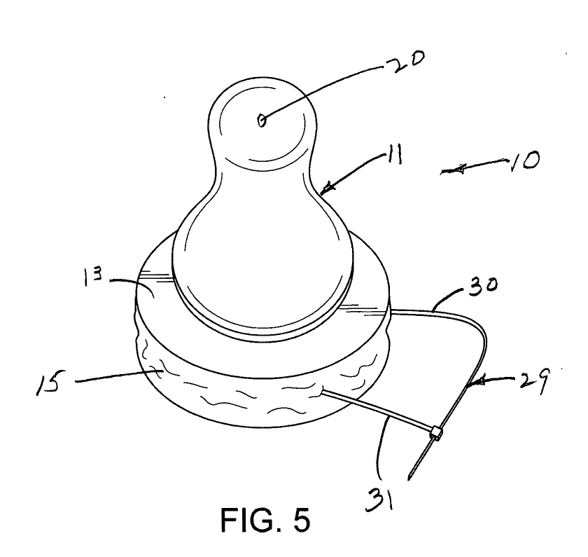

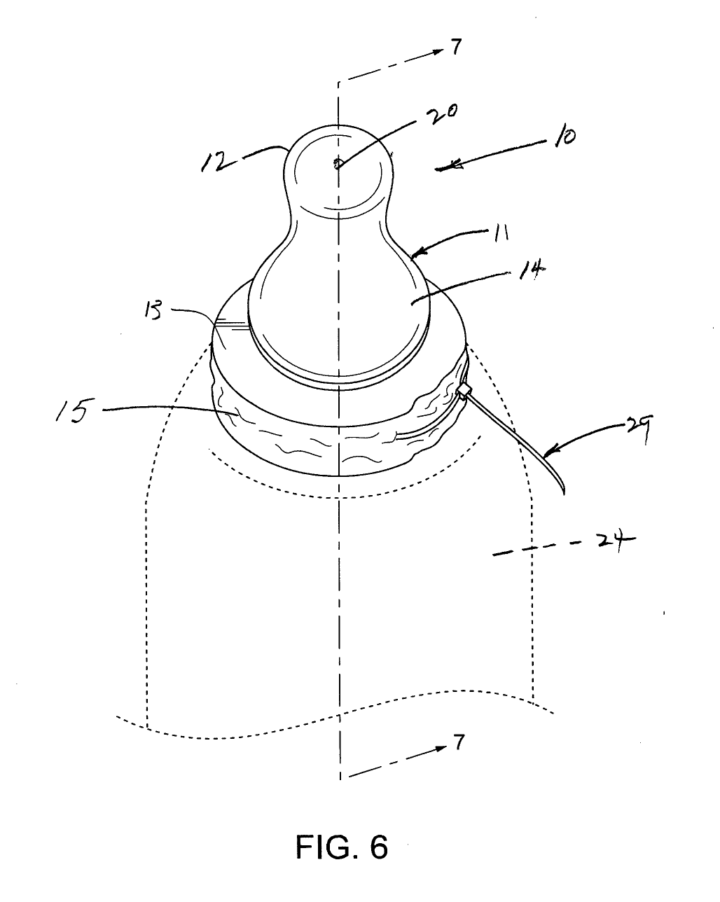

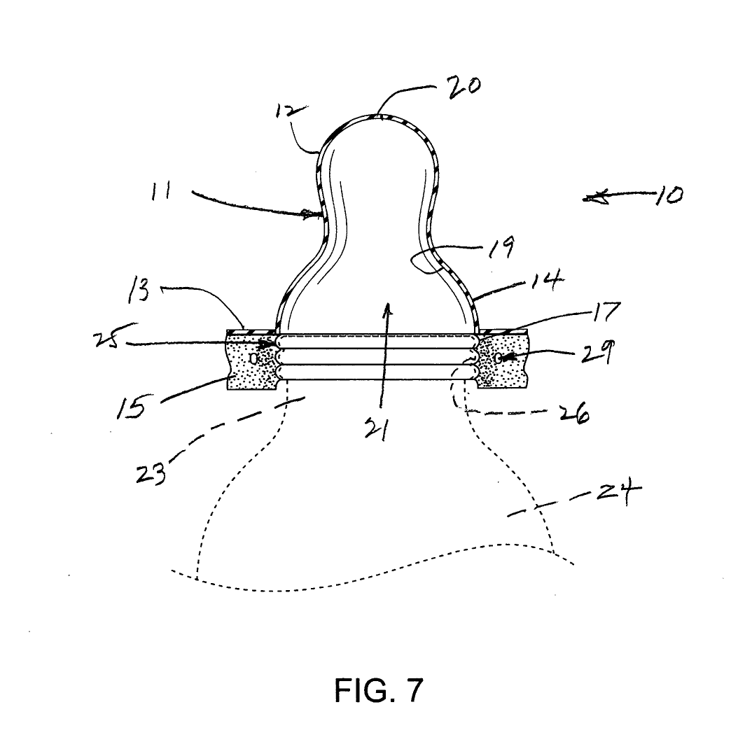

The flexibility of skirt 15, which allows the skirt to slip over a variety of sizes and configurations of bottle spouts, may be further enhanced by engaging a clamping member 29 on the skirt 15 or embedding the clamping member in the skirt, as shown in FIG. 5. A clamping member so arranged provides for constricting the socket inside the skirt onto a spout when the clamping member is tightened. A plastic strip such as a cable tie may be used, illustrated here as clamping member 29. It may be disposed on the outside of skirt 15, as shown by the upper leg 30 of clamping member 29, or it may be embedded in skirt 15 as shown by the lower leg 31 of clamping member 29 in FIG. 5. A clamping member such as cable tie 29 can be easily tied around a bottle spout as shown in FIGS. 6 and 7 and not loosened by an infant, thus making the assembly 10 secure and safe for infant use. An elastic band wound entirely and tightly around the outside of skirt 15 in place of the cable tie 29 may be utilized as an alternative form of clamping member.

Although the invention has been shown and described with reference to certain preferred embodiments, those skilled in the art undoubtedly will find alternative constructions after reading this disclosure. With this in mind, the following claims are intended to define and cover the full scope of protection to which the inventor is entitled, and they should be deemed to include all equivalent embodiments.

I claim:

1. A nursing nipple comprising
a funnel member having an orifice at a first end for transmitting fluid out of the nipple,
a base member at a second end of the funnel member,
a skirt member attached to and extending away from the base member forming a socket inside the skirt member adjacent to the base member, and
a channel formed in and extending through the skirt member, the base member and the funnel member for transmitting fluid to the orifice in the funnel member.

2. The nursing nipple of claim 1 in which walls of the socket are arranged for sealing engagement upon a spout of a bottle of fluid.

3. The nursing nipple of claim 1 in which thread elements are disposed inside the skirt member around the socket.

4. The nursing nipple of claim 1 in which an internally threaded cup is disposed within the socket.

5. The nursing nipple of claim 1 in which thread elements are formed in walls of the skirt member around the socket.

6. The nursing nipple of claim 1 in which the skirt member is secured to the periphery of the base member.

7. The nursing nipple of claim 1 in which the funnel member, base member and skirt member are integrally formed as a unit.

8. The nursing nipple of claim 1 in which a clamping member is engaged to the skirt member and arranged to constrict the socket inside the skirt member.

9. The nursing nipple of claim 8 in which the clamping member is embedded in the skirt member.

10. The nursing nipple of claim 8 in which the clamping member is a plastic tie strip.

11. The nursing nipple of claim 1 in which the skirt member is a soft flexible material.

12. The nursing nipple of claim 11 in which the material of the funnel member and the skirt member is a silicone compound.

13. The nursing nipple of claim 11 in which the skirt member is arranged to flexibly engage the neck of a bottle inside the socket formed by the skirt member.

14. The nursing nipple of claim 13 in which the skirt member is arranged to be bound to the neck of the bottle inside the socket formed by the skirt member.
